(19) United States
(12) Patent Application Publication
(10) Pub. No.: US 2012/0308398 A1
(43) Pub. Date: Dec. 6, 2012

(54) Positioning device for a wind power station and wind power station

(75) Inventors: Gabor-Josef Agardy, Herford (DE); Thomas Büker, Detmold (DE); Jürn Edzards, Schloss Holte-Stukenbrock (DE)

(73) Assignee: EMB SYSTEMS AG, Schloss Holte-Stukenbrock (DE)

(21) Appl. No.: 13/578,877

(22) PCT Filed: Feb. 15, 2011
(86) PCT No.: PCT/EP2011/000685

§ 371 Date: Aug. 14, 2012

(30) Foreign Application Priority Data
Feb. 23, 2010 (DE) 10 2010 009 050.6

(51) Int. Cl. F03D 11/00

(52) U.S. Cl. 416/244 R

(57) ABSTRACT

The invention relates to a positioning device for moving a rotor of a wind power station, comprising at least one support means (28) and a drive device (19) via which the torque active in the direction of the rotational axis (10) of the rotor can be produced. Said support means (28) support a rotational part (9) of the wind power station. The positioning device comprises a catch (40) which can be at least partially pivoted by the drive device (19), said pivoting enabling the support means (28) to be guided into or out from the support position. Said catch (40) can be moved into the support position by the drive device (19) such that the parts (9) which rotate move together. The invention also relates to a wind power station comprising said above-described positioning device.

The present invention relates to a positioning device for moving a rotor of a wind turbine having at least one support means and a drive device by means of which a moment acting in the direction of the axis of rotation of the rotor can be produced, wherein the support means are designed to rest against a rotatable part of the wind turbine. Furthermore, the invention relates to a wind turbine or wind energy system having a positioning device as described above.

When carrying out maintenance on wind turbines, the rotor and the moving parts of the drive train connected thereto must be fixed for reasons of safety. As well as the rotor hub, these include the low-speed and the high-speed shaft for example. In the prior art, locking devices, by means of which a pin can be fed into an associated recess of a rotating part of the wind turbine, such as a brake disk for example, are provided for this purpose. For problem-free locking and feeding-in of the pin, the rotor and the rotating part must be braked so that the recess lies in the striking direction of the pin. However, accurate braking is not possible in still air or when the rotor is idling. Positioning devices, by means of which the rotor together with the associated rotatable parts can also be moved even in the absence of wind, must therefore be provided.

A device for rotating a shaft of a wind turbine which is connected or coupled to a rotor, with which a toothed disk connected to the rotatable part of the wind turbine can be driven by means of a preferably motorized gear wheel, is disclosed in DE 100 31 473 C1, As a result of the interlocking connection of gear wheel and toothed disk. quite considerable forces act on the connection when there is a sudden gust of wind and the connection can be damaged as a result. This can make it impossible to lock and also to maintain the wind turbine.

It is the object of the present invention to design a positioning device for moving a rotor of a wind turbine and a corresponding wind turbine to be more reliable with regard to the disadvantages described above.

The object is achieved by means of a positioning device as claimed in claim 1 and by a wind turbine as claimed in claim 15. Further exemplary embodiments and details of the invention can be found in the following description and the dependent claims.

According to the invention, it is provided that the positioning device has a driving arrangement which can be at least partially pivoted by the drive device, the pivoting of which driving arrangement enables the support means to be guided out of a release position into a contact position or out of this contact position into the release position, wherein the driving arrangement can be moved into the contact position by the drive device such that the part of the wind turbine to be moved is moved concurrently. Instead of an interlocking connection, the connection between positioning device and the part of the wind turbine to be rotated is achieved by friction, The force exerted by the drive device on the support means which are pivoted thereby leads to static friction between support means and the part of the wind turbine to be moved. When the driving arrangement of the positioning device is pressed by means of its drive device against the part of the wind turbine to be moved, the driving arrangement is pulled or pushed by the drive device, for example, in a further movement phase so that the part of the wind turbine to be moved, which is securely clamped by the support means, is moved concurrently.

If, in the event of a gust of wind, a torque is now produced on the rotor shaft, this leads to a force acting perpendicular to the pressing or clamping direction, If this exceeds a preferably adjustable level, the static friction is overcome and the rotor is able to turn freely or at least with braking. Damage to the positioning device is prevented by its driving arrangement which is based on clamping. The drive device can be actuated by means of a motor, for example electrically or electromechanically, or hydraulically as well as manually.

In addition, the rotor can be pulled by means of the locking device out of a position in which a shaft is held between two permanently excited poles of the generator.

Advantageously, the pivotable part of the driving arrangement has a lever, by means of which the driving arrangement is mechanically connected to the drive device. No hydraulics are required for clamping: the solution is purely a mechanical solution. By actuating the lever, in a first movement phase, the drive device clamps the support means with the part of the wind turbine to be moved and then, in a second movement phase, is able to produce a torque in the direction of the axis of rotation of the rotor as a result of the overall concurrent movement of the lever in the circumferential direction. Here, the longitudinal direction of the lever preferably runs perpendicular to the contact surface to be clamped of the moving part of the wind turbine.

As a counter support for the clamping operation. the driving arrangement can preferably include a guide carriage, on which the pivotable part of the driving arrangement is pivotably fixed. The mounting of the lever, for example, can then act in conjunction with the supporting of the guide carriage, for example on a part of the wind turbine which is fixed to the frame, as a counter support.

In order to enable optimum guidance of the driving arrangement when the moving part of the wind turbine moves, the driving arrangement can advantageously be moved along a guide which is to be attached to a part of the wind turbine which is fixed to the frame, In particular. the guide is designed in the form of an arc, wherein the curvature of the guide preferably corresponds to the intended movement path of the driving arrangement, which is securely clamped to the part of the wind turbine to be moved. However, the guide can also take a different course if the support means are mounted on the further driving arrangement in a floating manner.

Advantageously, the driving arrangement comprises two support means, each having at least one contact surface, by means of which the driving arrangement is designed for improved clamping of the part of the wind turbine to be moved. At the same time, the support means are preferably arranged with the contact surfaces facing one another on the part of the driving arrangement which is designed in the form of a lever, namely in such a way that they are able to assume a friction connection on two opposing sides of the part of the wind turbine to be moved and are able to securely clamp the rotatable part between them. The rotatable part of the wind turbine is therefore securely clamped between the two contact surfaces when the lever is actuated by the drive device, and is released once more when the lever is pivoted in the opposite direction. The rotatable part of the wind turbine is preferably a brake disk, for example of a drum brake, or a smooth brake disk.

After a clamping operation and a subsequent movement of the positioning or feed device, the driving arrangement must be brought into a release position and subsequently into its starting position in order, for example, to move the rotor further. For this purpose, the driving arrangement can be partially pivoted back by the drive device in order to lift the contact surfaces of the support means from, for example, the brake disk once more. In order to guide the driving arrangement back, it has been shown to be advantageous to provide said driving arrangement with at least one stop, against which the pivotable part of the driving arrangement rests in a release position. The stop blocks an over-pivoting of the part of the driving arrangement which is designed in the form of a lever, for example, and therefore prevents the assumption of a self-blocking dead-point position or of a renewed clamping and concurrent movement of the rotor which prevents locking thereof. The force exerted by the drive device in the release position is therefore used to guide the driving arrangement back along the guide. The connection of the drive device and driving arrangement when using a guide can be realized by means of a simple articulated joint.

For the specific movement in both circumferential directions of the part of the wind turbine to be rotated, it can be expedient to be able to guide the stop into an out-of-operation position under the influence of a limiting force acting thereon. As a result, the part of the driving arrangement which is preferably designed in the form of a lever can be pivoted into a further clamping position, in which the concurrent movement of the appropriate rotor part of the shaft then becomes possible in the opposite direction.

Furthermore, the pivoting of the driving arrangement can be improved or assisted in that a driving arrangement brake, which is designed for preferably continuous contact as a permanent brake on a guide or on a part of the wind turbine which is fixed to the frame, is provided on the driving arrangement. This results in a force which opposes a non-pivoting displacement of the driving arrangement and therefore assists the pivoting of the lever. This applies particularly for devices with which the bearings of the positioning device only have a small amount of friction. Instead of being designed as a permanent brake; the driving arrangement brake can also be specifically switched when the positioning device is to be actuated.

Advantageously, the positioning device comprises a driving arrangement having an overload protection, which in particular is adjustable and with which a maximum of the static friction between the contact surface of the driving arrangement and, for example, of the brake disk of the wind turbine can be adjusted. This enables the positioning device to be adapted in particular to suit different wind classes. Such an overload protection can also be in the form of a measuring device for the current consumption of the motor and/or be formed by means of strain gauges or pressure sensors. The device can preferably be automatically guided into a release position on appropriate measured values.

Furthermore, if the positioning device is adequately sized, it can advantageously be used as a rotor brake and can replace the brakes previously provided in the prior art providing that it is arranged on a part of the system to be braked, in particular the brake disk of the system. At the same time, the positioning device can also act as a holding brake and hold the gondola in position. In addition, the positioning device can also be in the form of an azimuth brake, by means of which the gondola can be braked and/or fixed in the azimuth direction.

In order to bring one or more contact surfaces of the driving arrangement into an optimum contact position when pivoting the lever, the support means can be pivotably mounted on the lever itself and at the same time be guided in the non-pivoting part of the driving arrangement. As a result, they pivot relative to the lever itself when the lever is pivoted, and are able to apply the static friction in an optimum manner, for example to the brake disk of the wind turbine. This also counteracts a non-uniform wear of the contact surface linings.

Particularly advantageous is a design of the invention in which the drive device comprises a linear drive which enables a linear movement with a substantial component in the circumferential direction of the part to be rotated. According to the invention, the combination of linear drive which engages with a lever of the driving arrangement, and a driving arrangement which can be guided in an arc-shaped guide along a brake disk of a wind turbine, leads to a small, cost-effective and easy-to-construct as well as reliable positioning device, Wire cables, for example, can also be arranged on the driving arrangement instead of or in addition to a linear drive.

In order to further increase the reliability of the positioning device, the drive device. which can preferably be electrically actuatable, is provided with a manually actuatable positioning means, the actuation of which enables the driving arrangement to be moved. An example of this is a crank handle which is connected to the linear drive.

The object described above is likewise achieved by a wind turbine which has a positioning device as described above or below. The corresponding advantages of the positioning device also work to the advantage of the wind turbine.

In particular, the wind turbine is preferably provided with a brake disk which is arranged on the rotor side and against which the support means can be pressed for a friction connection. The positioning device can then be fixed in the supporting structure of the rotor and therefore use existing components. If the brake disks are at an adequate distance from the axis of rotation of the rotor, the positioning device can be made small due to the peripheral arrangement. On the other hand, an arrangement with a brake disk on the high-speed rotating side of a wind turbine can be of advantage due to the lower torques present here.

Furthermore, the wind turbine preferably includes a locking device which includes a pin which moves into a recess of the brake disk or of a further moving part in order to lock the rotor. Locking device and positioning device can therefore be arranged in contact with one another or adjacent to one another, which improves manual supervision of the locking process.

Particularly advantageously, the wind turbine is provided with a control device for automatic locking of the rotor, wherein the control device controls both the positioning device and the locking device. Appropriate sensors, which monitor the movement process and then trigger or actuate the locking device when the locking position has been reached, can be provided for this purpose.

Further advantages and details of the invention can be seen from the following description of the figures. In the schematic diagrams

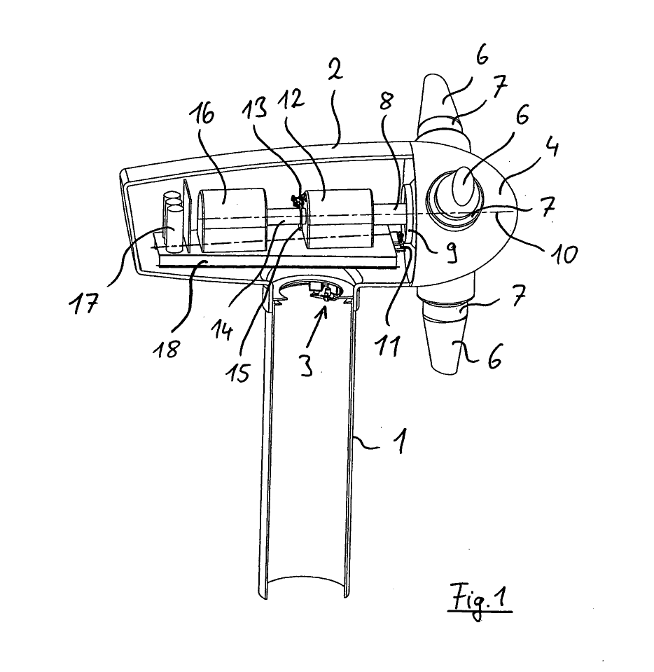

FIG. 1 shows a partial view of a wind turbine according to the invention,

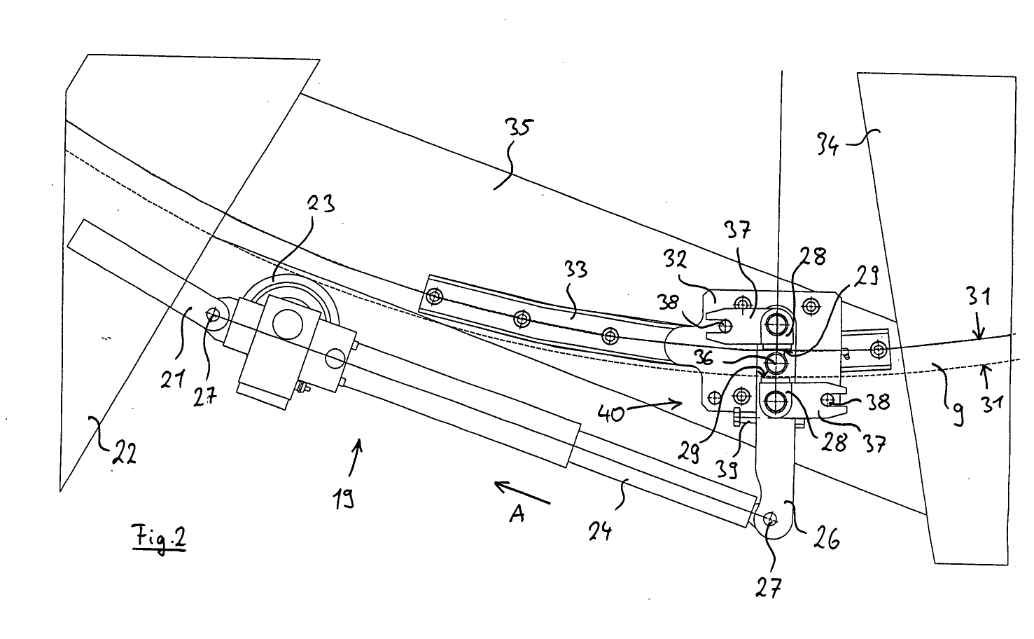

FIG. 2 shows a plan view of a part of the subject of the invention according to FIG. 1,

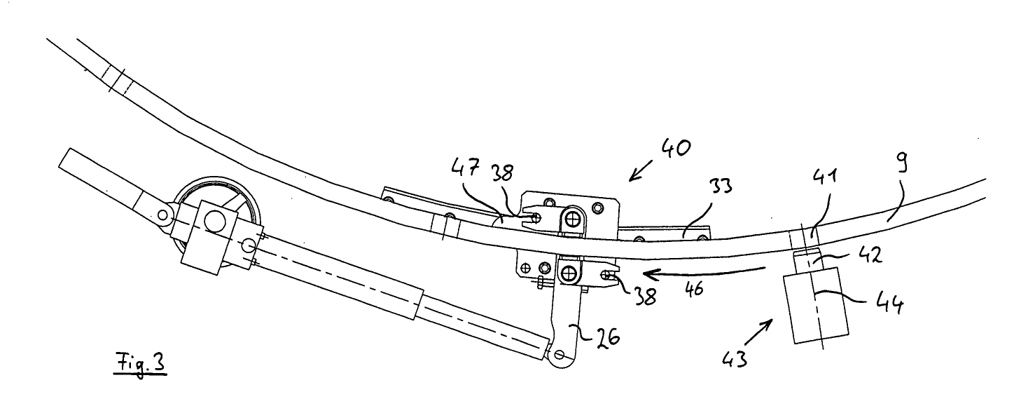

FIG. 3 shows a schematic diagram of the subject of the invention,

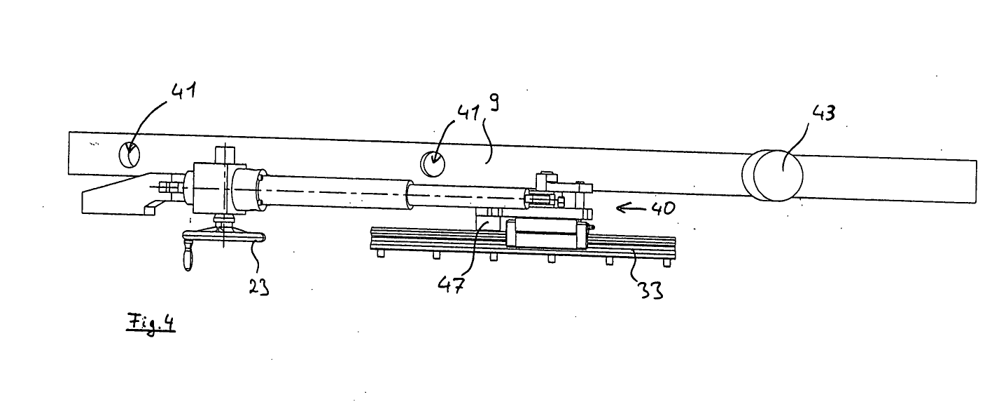

FIG. 4 shows the subject according to FIG. 3 in a further view,

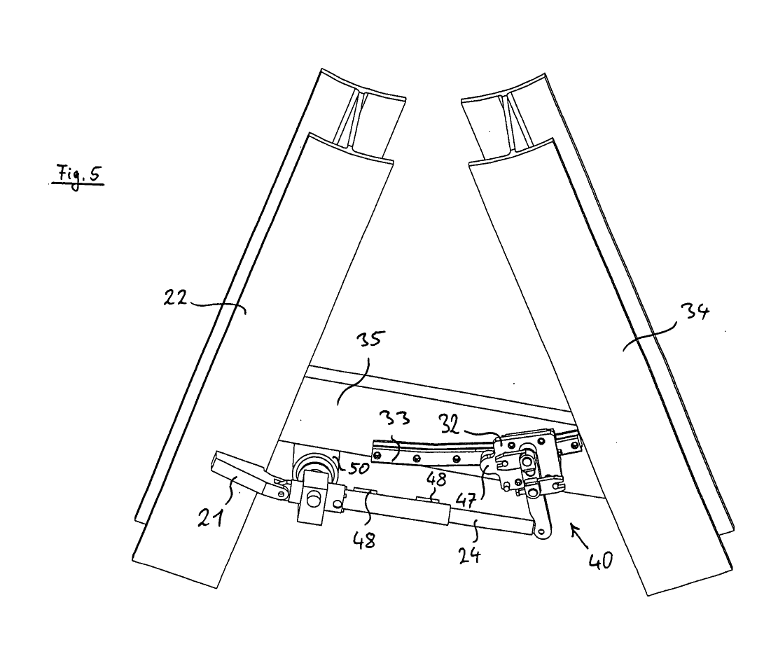

FIG. 5 shows a further subject of the invention in a partial view,

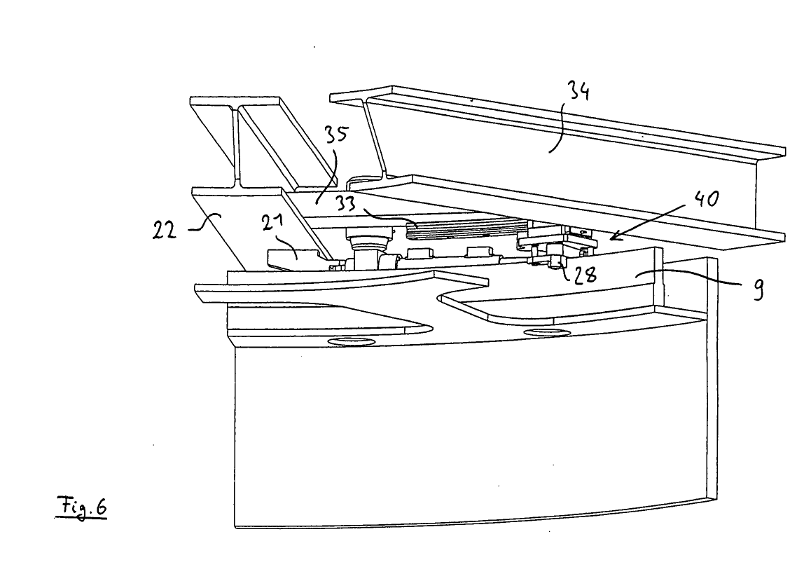

FIG. 6 shows the subject according to FIG. 5 in a further view.

Where appropriate, identically or similarly acting parts are allocated identical reference numbers. Individual technical characteristics of the exemplary embodiments described below together with the characteristics of the exemplary embodiments described above can also lead to improvements according to the invention.

A section of a wind turbine according to the invention is shown in FIG. 1. A gondola 2 is rotatably mounted on a tower 1. The free rotation in the gondola 2 can be restricted or prevented by means of an azimuth brake 3. The rotor includes a rotor hub 4, on which three rotor blades 6 are arranged in a radial direction. These can be adapted to suit the particular wind conditions by means of blade adjusters 7.

The rotor, which has a rotor shaft 8, likewise includes an annular brake disk 9 which rotates at a distance about an axis of rotation 10 of the rotor and acts together with a positioning device 11 according to the invention. A rotor brake 13, which engages with a further brake disk 15 arranged on a further rotor shaft 14, is fixed to a gearbox housing 12. The further rotor shaft 14 leads from the gearbox to a generator 16. Three inverters 17 transform the current generated in the generator 16.

The circumference of the annular brake disk 19 and therefore its circumferential distance from the axis of rotation 10 is considerably greater than, for example, that of the brake disk 15, on account of which the appropriate positioning device can be made adequately small. The positioning device according to the invention can be fixed to a platform of the gondola 2, for example; it can however also be fixed to other load-bearing parts in the gondola 2.

According to FIG. 2, the positioning device according to the invention is arranged with its drive device 19 fixed to the frame. For this purpose, the drive device 19 is pivotably fixed to a support 22 of the gondola 2 by means of a flange 21. The drive device 19 is designed in the form of a linear drive which can be moved by means of a crank handle 23. In a following exemplary embodiment, instead of a crank handle, an electric motor, which however can also be used in addition to a crank handle as part of the drive device, is provided. The linear drive 19 is flexibly connected to a lever 26 by means of a push rod 24 As a result of the two articulated joints 27, the push rod 24 is able to move the lever 26 along the peripheral direction of the brake disk 9 which is shown only by means of a dashed line in this diagram.

Two support means 28, each of which has at least one contact surface 29 facing the brake disk 9, are arranged on the lever 26. In the starting or release position shown, the contact surfaces 29 are at a distance from sides 31 of the brake disk. The rotor is therefore able to rotate freely.

Furthermore, the lever 26 is pivotably mounted on a guide carriage 32, which can be moved on a guide rail 33 which forms a guide. This guide rail follows the curve of the brake disk 9 and is fixed to the frame on an intermediate support 35 between the support 22 and a support 34.

In order to move the brake disk and therefore the rotor of the wind turbine, the push rod 24 of the drive device 19 is moved in direction A. As a result, the lever 26 pivots on the guide carriage 32 about an axis of rotation or pivoting axis 36, as a result of which the contact surfaces 29 press against the sides 31. The guide carriage 32 therefore forms a non-pivotable part of a driving arrangement 40. A driving arrangement brake, which is designed in the form of a permanent brake 47 and which rests permanently against the guide rail 33, is provided to assist the pivoting movement. As a result of the pivoting of the lever, the support means 28, which rest against stops 38 by means of guide flange 37, move away from the stops and in the direction of the sides 31, and the brake disk is clamped between the contact surfaces 29.

In doing so, the static friction between the contact surfaces 29 and the sides 31 of the brake disk 9 is sufficiently great that further movement of the push rod 24 in direction A causes the brake disk 9 to move with it. which leads to the required rotational movement of the rotor and produces a moment acting in the direction of the axis of rotation of the rotor. At the same time, an overload protection device 39 limits the force exerted by the lever 26 or its support means 28 on the brake disk, enabling a force exerted on the connection by the brake disk during a gust of wind to cause the brake disk to slip at an adjustable value. As soon as the driving arrangement 40 reaches the end of the guide rail 33 in direction A, the clamp can be released once more by moving the push rod 24 in the opposite direction to direction A. In this case, the lever pivots back until the guide flange 37 rests against the stop 38 once more, which corresponds to a release position of the driving arrangement. Further extension of the push rod 24 in the opposite direction to direction A then leads to the guide carriage or the driving arrangement 40 being pushed back along the guide rail 33 into the starting position shown in FIG. 2.

The brake disk 9 can be moved along its circumference by means of the movement of the driving arrangement 40 along the guide rail 33 until a recess 41 provided in the brake disk 9 is disposed before a pin 42 of a pin engagement or locking device 43. The pin 42 can then move along the axis 44 into the recess 41, as a result of which the rotor of the wind turbine is locked. The maintenance personnel can then carry out the required maintenance.

Particularly advantageous here is an automatic control system, with which the brake disk, monitored for example by means of sensors, is moved until the position shown in FIG. 3 is reached, While, because of the fixed stops 38, the manually operated positioning device is only able to move the brake disk 9 in the circumferential direction 46, with different embodiments of the invention, the stops can also pivot in a spring-loaded manner, for example, so that, above a certain force, the brake disk 9 can then be moved in the opposite direction as a result of a pivoting of the lever 26 with clamp.

A particular advantage of the invention lies in the possibility of using already existing brake disks and, because of the compact structure of the device, the ability to arrange this close to a locking device 43, which is advantageous for visual inspection.

In particular, the arrangement of a permanent brake 47, which, for example, comprises a spring with a friction lining and holds the driving arrangement 40 on the guide rail 33 with a braking action, is shown in the view according to FIG. 4. This assists the pivoting of the lever 26. Advantageously, the guide rail 33 can be designed to be long enough for the distance between two recesses 41 to be overcome as a result of the movement of the driving arrangement 40 along the guide rail 33, thus enabling one of the recesses to be positioned before the pin engagement device 43 during only one push or pull movement.

Instead of the crank handle 23, the positioning device according to the invention according to FIG. 5 has an electric motor 50, by means of which the push rod 24 can be moved. End position switches 48 integrated within the push rod can send signals relating to the position of the push rod 24 and therefore of the guide carriage 32 to a control device, which is not shown in more detail. In the diagram according to FIG. 5, the brake disk 9 is not shown in order to provide a better view of the positioning device.

The subject according to FIG. 5 is shown additionally with the brake disk 9 of the wind turbine in FIG. 6. In spite of the small dimensions of the contact surfaces compared with the available area of the brake disk, which is only overlapped to an extremely small extent, preferably less than 30%, by the contact surfaces when viewed in the direction of the axis of rotation, the static friction effected by the pressing of the contact surfaces 29 is sufficiently large to rotate the rotor. Larger distances between supports 22, 35 and 34 which are securely attached to the frame can also be overcome by alternative dimensions of the fixing flange 21 and the guide rail 33 and/or the driving arrangement 40. For example, the guide rail 33 can be made higher or flatter and the driving arrangement 40, which is preferably constructed from plate-shaped elements, can have different dimensions in the direction of an axis of rotation 10. By increasing the size of the support means 28 and accordingly the contact surfaces 29, the device described can also be designed in particular as a rotor brake. For this purpose, the guide carriage 32 can move along the direction of rotation 46 against a stop, which is not shown in more detail, of the guide rail 33 and there remain in the engaged position, in which the rotor can be braked by means of static friction.

What is claimed is:

1. A positioning device for moving a rotor of a wind turbine having at least one support means (28) and a drive device (19) by means of which a moment acting in the direction of the axis of rotation (10) of the rotor can be produced, wherein the support means (28) are designed to rest against a rotatable part (9) of the wind turbine, characterized in that the positioning device has a driving arrangement (40) which can be at least partially pivoted by the drive device (19), the pivoting of which driving arrangement enables the support means (28) to be guided into or out of a contact position, wherein the driving arrangement (40) can be moved into the contact position by the drive device (19) such that the part (9) to be moved is moved concurrently.

2. The positioning device as claimed in claim 1, characterized in that the pivotable part of the driving arrangement (40) has a lever (26), by means of which the driving arrangement (40) is mechanically connected to the drive device.

3. The positioning device as claimed in claim 1, characterized in that the driving arrangement (40) includes a guide carriage (32), on which the pivotable part of the driving arrangement (40) is pivotably fixed.

4. The positioning device as claimed in claim, characterized by a guide which can be moved along the driving arrangement (40).

5. The positioning device as claimed in claim 1, characterized by a driving arrangement brake, which is provided for pivoting the driving arrangement (40) and is designed for preferably continuous contact with the guide.

6. The positioning device as claimed in claim 1, characterized in that the driving arrangement (40) has two support means (28), each having at least one contact surface (29), by means of which the driving arrangement is designed to clamp the part (9) of the wind turbine to be moved,

7. The positioning device as claimed in claim 6, characterized in that the pivotable part of the driving arrangement (40) has a lever 26, by means of which the driving arrangement (40) is mechanically connected to the drive device, wherein the support means (28) are arranged with the contact surfaces (29) facing one another on the lever (26) in such a way that they are able to assume a friction connection on two sides (31) of the part (9) of the wind turbine to be moved.

8. The positioning device as claimed in claim 1, characterized in that the driving arrangement (40) has at least one step (38), against which the pivotable part of the driving arrangement (40) rests in a release position.

9. The positioning device as claimed in claim 8, characterized in that the stop (38) can be guided into an out-of-operation position under the influence of a limiting force acting thereon.

10. The positioning device as claimed in claim 1, characterized in that the driving arrangement (40) has a preferably adjustable overload protection (39).

11. The positioning device as claimed in claim 1, characterized by being designed as a rotor or azimuth brake.

12 The positioning device as claimed in claim 1, characterized in that the support means (28) are guided on the driving arrangement (40) and are pivotably mounted on the pivotable part of the driving arrangement (40).

13. The positioning device as claimed in claim 1, characterized in that the drive device (19) has a linear drive.

14. The positioning device as claimed in claim 1, characterized in that the drive device (19) has a manually actuatable positioning means (23), the actuation of which enables the driving arrangement (40) to be moved.

15. A wind turbine characterized by a positioning device as claimed in claim 1.

16. The wind turbine as claimed in claim 15 having a brake disk, characterized in that the support means (28) are designed to assume a friction connection with the brake disk.

17. The wind turbine as claimed in claim 15, characterized by a locking device (43) which includes a pin (42) which moves into a recess (41) in order to lock the rotor.

18. The wind turbine as claimed in claim 15, characterized by a control device for automatic locking of the rotor, wherein the control device is designed to control both the positioning device and the locking device (43).
